(19) United States
(12) Patent Application Publication
(10) Pub. No.: US 2007/0206225 A1
(43) Pub. Date: Sep. 6, 2007

(54) Printing apparatus, printing method, and computer program product

(76) Inventors: Michinari Shinohara, Kanagawa (JP); Akiko Takatsu, Kanagawa (JP)

Correspondence Address: COOPER & DUNHAM, LLP, 1185 AVENUE OF THE AMERICAS, NEW YORK, NY, 10036, US

(21) Appl. No.: 11/713,507

(22) Filed: Mar. 2, 2007

(30) Foreign Application Priority Data
Mar. 2, 2006 (JP) 2006-056529
Jan. 9, 2007 (JP) 2007-001731

(51) Int. Cl. G06F 3/12

(52) U.S. Cl. 358/1.16; 358/1.15

(57) ABSTRACT

An apparatus for printing input image data includes an image obtaining unit that obtains image data stored in a storage unit of an external apparatus and a printing unit that prints obtained image data. The image obtaining unit includes an image-data requesting unit that requests the image data to the external apparatus, and obtains the image data from the external apparatus that responded a request from the image-data requesting unit.

### CROSS-REFERENCE TO RELATED APPLICATIONS

The present document incorporates by reference the entire contents of Japanese priority documents, 2006-056529 filed in Japan on Mar. 2, 2006 and 2007-001731 filed in Japan on Jan. 9, 2007.

### BACKGROUND OF THE INVENTION

1. Field of the Invention

The present invention relates to a printing apparatus, such as a printer, a copier, or a multifunction product (MFP), a printing method, and a computer program product.

2. Description of the Related Art

Conventionally, PUSH-type printing has been performed in which image data is transmitted from an external apparatus, such as a personal computer (PC), via a communication network, such as a Local Area Network (LAN) or the Internet, to a printing apparatus that prints on a printing sheet (see, for example, Japanese Patent Application Laid-Open Publication No. 2006-018853). That is, with a user operating such an external apparatus as a PC, image data can be printed by the printing apparatus.

However, in the conventional printing apparatus, only such PUSH-type printing can be performed. That is, it is impossible for a user to operate the printing apparatus to print image data stored in an external apparatus. Therefore, there is a problem of low expandability of print targets.

### SUMMARY OF THE INVENTION

It is an object of the present invention to at least partially solve the problems in the conventional technology.

An apparatus for printing input image data, according to one aspect of the present invention, includes an image obtaining unit that obtains image data stored in a storage unit of an external apparatus; and a printing unit that prints obtained image data.

A method of printing input image data, according to another aspect of the present invention, includes obtaining image data stored in a storage unit of an external apparatus; and printing obtained image data.

A computer program product according to still another aspect of the present invention includes a computer-usable medium having computer-readable program codes embodied in the medium that when executed cause a computer to execute obtaining image data stored in a storage unit of an external apparatus; and printing obtained image data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a multifunction product (MFP) according to a first embodiment of the present invention and many external apparatuses connected to the MFP via a communication network;

FIG. 2 is a table of an example of an image data management table held in management servers shown in FIG. 1;

FIG. 3 is a block diagram of a hardware configuration of the MFP shown in FIG. 1;

FIG. 4 is a table of a viewing/obtainment management table included in a viewing/obtainment management database (DB) shown in FIG. 1;

FIG. 5 is a block diagram of a configuration of the MFP shown in FIG. 1;

FIG. 6 is a schematic of an operating unit according to the first embodiment;

FIG. 7 is a schematic of an example of an initial display (basic screen) displayed on a touch panel according to the first embodiment;

FIG. 8 is a schematic of an abridged display (simple display) displayed on the touch panel;

FIG. 9 is a flowchart of an operational processing performed by the MFP shown in FIG. 1;

FIG. 10 is a schematic of an identification (ID) and password request screen displayed on the touch panel;

FIG. 11 is a schematic of a folder group displayed on the touch panel;

FIG. 12 is a sequence diagram of the operation according to the first embodiment;

FIG. 13 is a schematic of an example of a list of thumbnail images displayed on the touch panel;

FIG. 14 is a schematic of an example of a file name list displayed on the touch panel;

FIG. 15 is a schematic of another example of the initial display (basic screen) displayed on the touch panel;

FIG. 16 is a schematic of an example of a thumbnail image list displayed on the touch panel by a display processing unit according to a modification example of the first embodiment;

FIG. 17 is a table of an example of a viewing/obtainment management table according to a second embodiment of the present invention;

FIG. 18 is a block diagram of a configuration of an MFP according to the second embodiment; and

FIG. 19 is a flowchart of a process performed by the MFP shown in FIG. 18 until the MFP obtains image data.

### DETAILED DESCRIPTION OF THE PREFERRED EMBODIMENTS

Exemplary embodiments of the present invention are explained in detail below with reference to the accompanying drawings. Various keys and icons explained below are taken as examples of operation condition items according to the embodiments.

One embodiment is achieved by a printing apparatus including a communication control apparatus, and is exemplarily applied to a multifunction product (MFP) 21, which is a type of multifunction printing apparatus including a copy function, a facsimile (FAX) function, a printing function, a scanner function, a function of distributing an input image (a document image read through the scanner function or an image input through the printing function and the FAX function), a function of storing received FAX documents and copy documents in an internal hard disk, and other functions.

Although an example is explained in which the printing apparatus is applied to an MFP in the present embodiment, the printing apparatus can be applied not only to such an MFP but also to other electronic apparatuses. An example of such electronic apparatuses can be business office equipment placed in a business environment, such as a copier and a FAX. With the printing apparatus being applied to such business office equipment, apparatuses present in the office environment can be cooperated with one another.

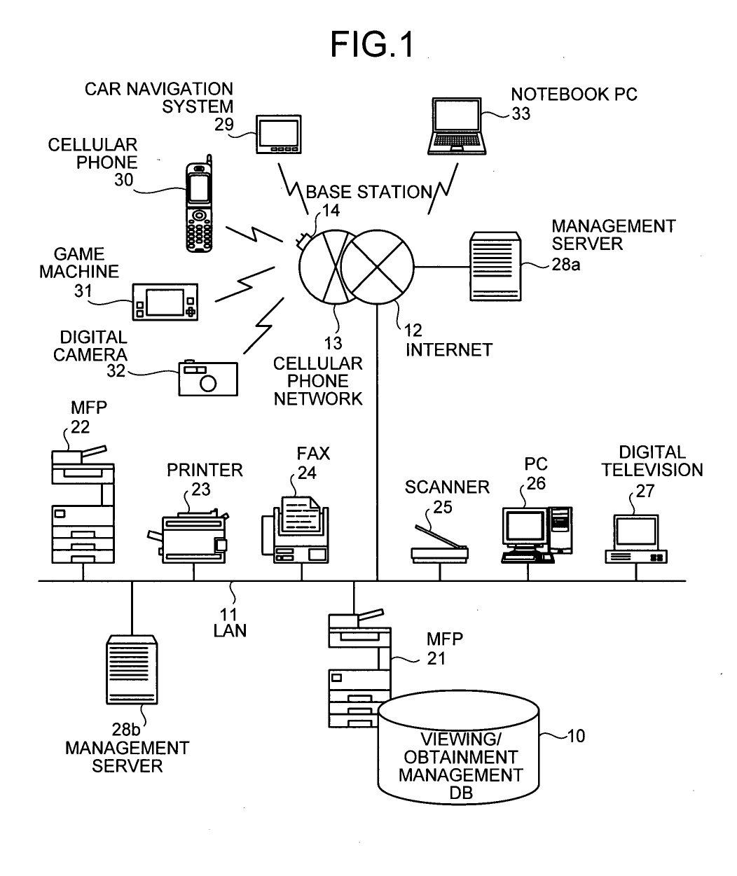

FIG. 1 is a drawing of the MFP 21 according to the first embodiment and many external apparatuses connected to the MFP 21 via a communication network. As shown in FIG. 1, the MFP 21 is connected via a local area network (LAN) 11 to a plurality of external apparatuses (such as another MFP 22, a printer 23, a FAX 24 a scanner 25, a PC 26, a digital television 27, and a management server 28b). The MFP 21 is connected via an Internet 12 to external apparatuses (such as a management server 28a and a notebook PC 33). The MFP 21 can process data received from these external apparatuses (for example, data broadcast received by the digital television 27) by using the functions mentioned above.

Furthermore, the management server 28a is intercommunicably connected via the Internet 12, a mobile phone network 13, and a base station 14 to external apparatuses (such as a car navigation system (including an “automobile”) 29, a mobile phone (including a “personal handyphone system (PHS) terminal and a “personal digital assistant (PDA)”) 30, a game console 31, and a digital camera 32).

Still further, the external apparatuses may be arbitrary as long as they are connectable to the network, and may include, in addition to the mobile phone 30, the car navigation system 29, the game console 31, the digital camera 32, and the notebook PC 33, for example. Other examples of such external apparatuses include, although not depicted, a wrist watch, a vending machine, a water meter, and a gas meter, for example. These external apparatuses transmit and receive information via the network, such as the Internet 12 or the mobile phone network 13. Also, these external apparatuses may be connected to a mobile phone or the like for communication, or may communicate via a unique communicating unit mounted on each apparatus. Furthermore, the external apparatus according to the present embodiment includes a storage unit, in which image data is stored.

Although not depicted, the network may have connected thereto a server apparatus, such as a Simple Mail Transfer Protocol (SMTP) server, a File Transfer Protocol (FTP) server, or a distribution server. The distribution can transmit and receive electronic mails and transfer files via a public network, and can communication with a FAX apparatus outside office. Via these server apparatuses, the MFP 21 can transmit and receive various types of information.

As shown in FIG. 1, being connected to the networks, the MFP 21 can intercommunicate with the external apparatuses (including business office equipment), such as the PC 26 and the notebook PC 33. Also, with a storage device, such as a hard disk, being incorporated, the MFP 21 has evolved into a so-called network MFP, thereby answering various needs from users.

The management servers 28a and 28b are servers that manage information transmitted and received between the external apparatuses and the MFP 21, and can include a function as a Web server. Also, as exemplified by the management server 28b, these management servers may be connected to the LAN 11, to which the MFP 21 is connected, or, as exemplified by the management server 28a, the management servers may be connected via a public network, such as the Internet 12. Furthermore, the number of management servers connected via a network is not restrictive, and may be one, plural, or none if not required.

The management servers 28a and 28b are general-purpose computers, and have implemented thereon an image management function for managing image data. The image management function may be, for example, a program installed via a storage medium, such as a compact disk-read only memory (CD-ROM), or a network. With the program being executed by a central processing unit (CPU) of the relevant one of the management servers 28a and 28b, functions explained below are executed.

The management servers 28a and 28b manage image data stored in external apparatuses not continuously connected to a network (for example, the mobile phone network 13 or the Internet 12). In the present embodiment, when any of these external apparatuses (for example, the car navigation system 29, the game console 31, the digital camera 32, and the notebook PC 33) is connected to the mobile phone network 13 or the Internet 12, the management server 28a synchronizes with the external apparatus to store image data held in the external apparatus in a storage unit of the management server 28a. That is, the management server 28a manages in a centralized manner all pieces of image data stored in these apparatuses. Such management may be performed not by the management server 28a but by the management server 28b.

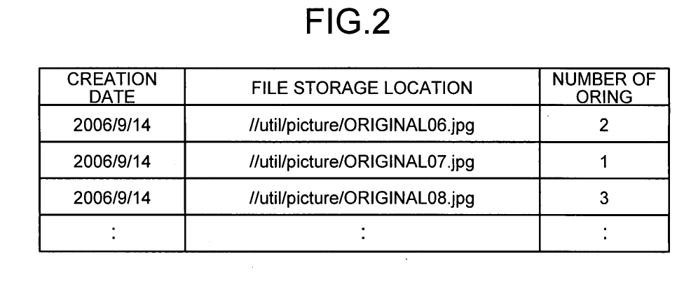

Furthermore, the management servers 28a and 28b manage image data information in a form of an image data management table. FIG. 2 is a drawing of an example of configuration of an image data management table held in the management servers 28a and 28b. As shown in FIG. 2, in the image data management table, an image data creation date, a file storage location in which image data is stored, and the number of pages are managed in association with one another. In response to a request for transmitting image data from the MFP 21, the management servers 28a and 28b transmit the image data.

It has been already performed that the user operates the PC 26 shown in FIG. 1 or the like to output image data to the MFP 21 for printing. However, in recent years, with the improvement of interface technology in MFPs, the desire to operate an MFP to use image data stored in another external apparatus has been increased. Thus, in the present embodiment, the user operates the MFP 21 to request through the MFP 21 an output of image data from an external apparatus, such as the PC 26, thereby obtaining the image data as a print target from the external apparatus. With this, image data not stored in the MFP 21 can be used for printing or other purposes. Such a technology for actively requesting an output of image data from the external apparatus is a feature that has not been used in the conventional MFP.

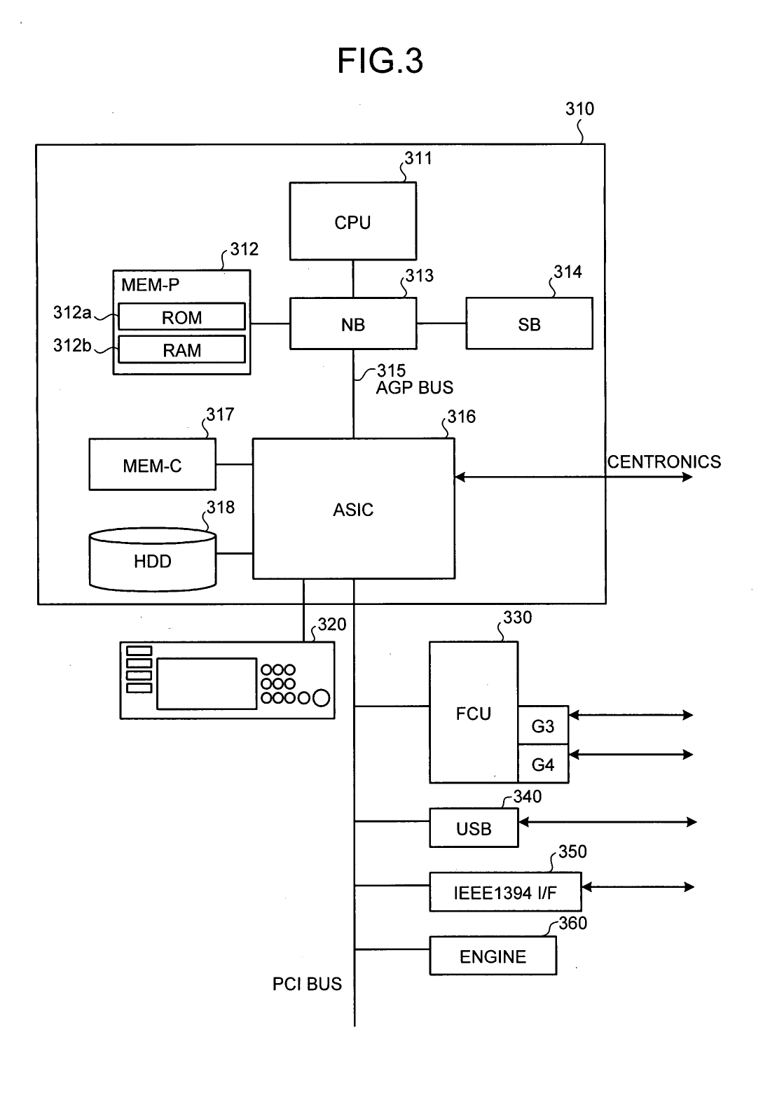

FIG. 3 is a block diagram of a hardware configuration of the MFP 21 according to the first embodiment. As shown in FIG. 3, the MFP 21 is configured with a controller 310 and an engine unit (engine) 360 being connected to each other via a Peripheral Component Interconnect (PCI) bus. The controller 310 is a controller that controls the entire MFP 21, rendering, communications, and an input from an operating unit 320. The engine unit 360 is, for example, a printer engine connectable to the PCI bus, and is, for example, a black-and-white plotter, a 1-drum color plotter, a 4-drum color plotter, a scanner, or a FAX unit. The engine unit 360 includes, in addition to a so-called engine portion, such as a plotter, image processing portions for error diffusion, gamma transformation, and others.

The controller 310 includes a CPU 311, a northbridge (NB) 313, a system memory (MEM-P) 312, a southbridge (SB) 314, a local memory (MEM-C) 317, an application specific integrated circuit (ASIC) 316, and a hard disk drive (HDD) 318, with the NB 313 and the ASIC 316 being connected therebetween with an accelerated graphics port (AGP) bus 315. Also, the MEM-P 312 further includes a read only memory (ROM) 312a and a random access memory (RAM) 312b.

The CPU 311 performs controls over the entire MFP 21, includes a chip set formed of the NB 313, the MEM-P 312, and the SB 314, and is connected to other devices via this chip set.

The NB 313 is a bridge for connection of the CPU 311 with the MEM-P 312, the SB 314, and the AGP bus 315, and includes: a memory controller that controls, for example, reading and writing with respect to the MEM-P 312; a PCI master; and an AGP target.

The MEM-P 312 is a system memory for use as, for example, a memory for storing programs and data, a memory for developing programs and data, or a printer's memory for rendering, and includes the ROM 312a and the RAM 312b. The ROM 312a is a read-only memory for use as a memory for storing programs and data, whilst the RAM 312b is a writable and readable memory for use as, for example, a memory for developing programs and data or a printer's rendering memory.

The SB 314 is a bridge for connection of the NB 313 with PCI devices and peripheral devices. The SB 314 is connected to the NB 313 via the PCI bus. To this PCI bus, a network interface (I/F) unit is also connected, for example.

The ASIC 316 is an Integrated Circuit (IC) dedicated to image processing, contains hardware components for image processing, and serves as a bridge for connecting the AGP bus 315, the PCI bus, the HDD 318, and the MEM-C 317. The ASIC 316 includes: a PCI target; an AGP master; an arbiter (ARB), which is a core of the ASIC 316; a memory controller that controls the MEM-C 317; a plurality of Direct Memory Access Controllers (DMACs) for image data rotation and others by a hardware logic and others; and a PCI unit for data transfer with the engine unit 360 through the PCI bus. To the ASIC 316, a fax control unit (FCU) 330, a universal serial bus (USB) 340, and the Institute of Electrical and Electronics Engineers (IEEE) 1394 I/F 350 are connected via the PCI bus.

The MEM-C 317 is a local memory for use as an image buffer for copying or a coding buffer. The HDD 318 is a storage unit for storing image data, programs, font data, and forms.

The AGP bus 315 is a bus interface for a graphics accelerator card suggested for increasing the speed of graphic processing, and increases the speed of the graphics accelerator card by directly accessing the MEM-P 312 with a high throughput.

A touch panel included in the operating unit 320 according to the present embodiment may be a touch panel of an apparatus solely having a function of any one of a copier, a FAX, a printer, and others, or may be a touch panel of an apparatus having these functions in combination.

Under the control of the CPU 311 shown in FIG. 3, recognition of a press on a key of the operating unit 320 (hereinafter including “a touch panel 600”) and display as such are performed.

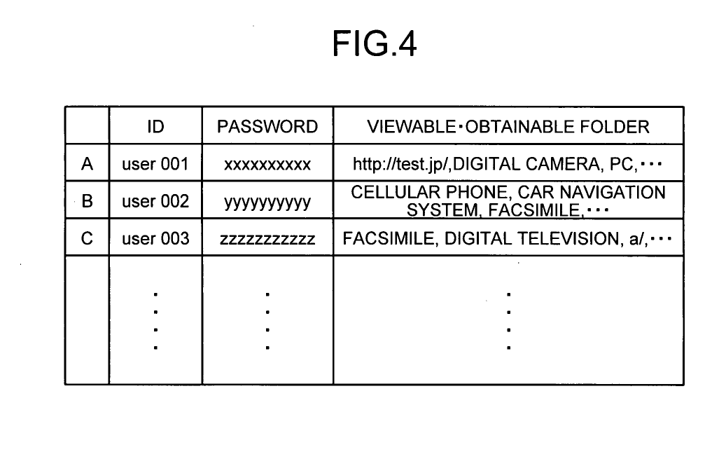

In a ROM 212a, a viewing/obtainment management database (DB) 10 is constructed. The viewing/obtainment management DB 10 is configured with the viewing/obtainment management table having a layout as shown in FIG. 4, and is a DB for managing folder data viewable or obtainable for each user. Furthermore, the ROM 212a has stored therein a program for executing steps (S1 to S8), which will be explained further below.

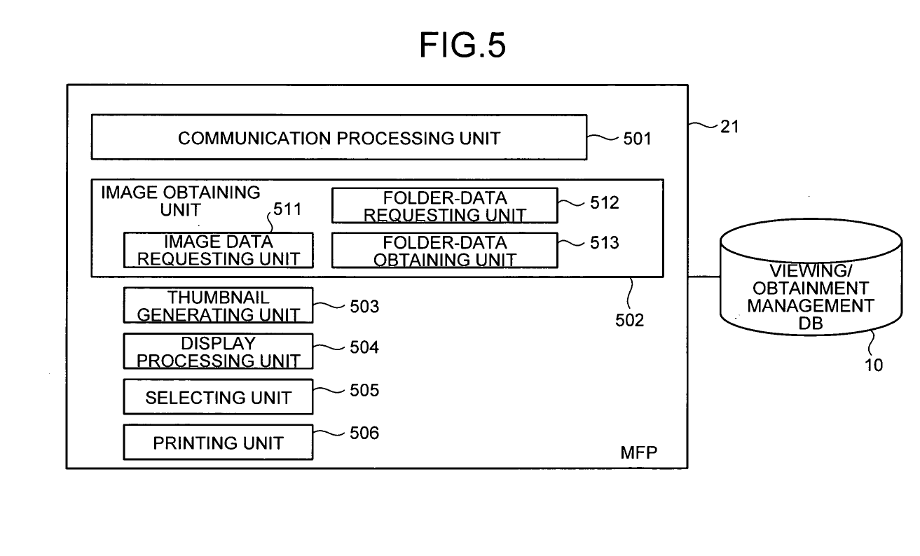

FIG. 5 is a block diagram of the configuration achieved by the program mentioned above in the MFP 21 according to the first embodiment. As shown in FIG. 5, the MFP 21 includes a communication processing unit 501, an image obtaining unit 502, a thumbnail generating unit 503, a display processing unit 504, a selecting unit 505, and a printing unit 506.

The communication processing unit 501 transmits and receives data to and from external apparatuses via the networks (the LAN 11, the Internet 12, and the mobile phone network 13) by following the image obtaining unit 502 and others, which will be explained below.

The image obtaining unit 502 includes an image-data requesting unit 511, a folder-data requesting unit 512, and a folder-data obtaining unit 513 to obtain image data stored in the storage unit of each external apparatus. Also, when obtaining image data, the image obtaining unit 502 requests the communication processing unit 501 to receive the image data.

The image-data requesting unit 511 requests an external apparatus to transmit image data. With this, the communication processing unit 501 transmits a transmission request to the external apparatus. This allows the image obtaining unit 502 to obtain the image data from the requested external apparatus. When image data is managed by unit of folder at the storage unit of the external apparatus and the MFP 21 issues a transmission request for image data by unit of folder, the folder-data requesting unit 512 issues a transmission request, which will be explained below.

The folder-data requesting unit 512 requests an external apparatus to transmit image data contained in each folder. With this, the communication processing unit 501 transmits a transmission request to the external apparatus. In the present embodiment, the folder-data requesting unit 512 issues a transmission request for image data in the folder at a timing of specifying the folder by the user. According to the present embodiment, the transmission request timing is not meant to be restricted to such a timing mentioned above and, alternatively, a transmission request may be issued in advance before the user specifies a folder.

The folder-data obtaining unit 513 obtains, from the external apparatus responding to the transmission request from the folder-data requesting unit 512, image data contained in the folder and folder data through a receiving process by the communication processing unit 501.

The thumbnail generating unit 503 generates thumbnail image data from the image data obtained by the image obtaining unit 502.

The display processing unit 504 performs a process of displaying the generated thumbnail image data on the touch panel of the operating unit 320, which will be explained further below. Details about display forms are explained further below.

The selecting unit 505 selects image data as a print target. In the present embodiment, when the user selects a thumbnail image displayed on the operating unit 320, the selecting unit 505 selects image data from which the thumbnail image selected by the user is generated as a print target. Also, the selecting unit 505 may select a plurality of pieces of image data as print targets. Furthermore, the selecting unit 505 may select one or plurality of pieces of image data stored in the storage unit of each external apparatus.

The printing unit 506 performs printing of the image data selected by the selecting unit 505. Also, when the selecting unit 505 selects a plurality of pieces of image data, the printing unit 506 performs collective printing of the selected pieces of image data.

Referring back to FIG. 4, the viewing/obtainment management DB 10 manages a user ID, a password, and viewable/obtainable folder in association with one another. Also, the field “viewable/obtainable folder” contains folders from which image data is viewable or obtainable by the user. Furthermore, this field may have set therein an external apparatus connected via a network as a viewable/obtainable folder. Furthermore, this field may have set therein a predetermined folder in an external apparatus as a viewable/obtainable folder. Still further, this field can have set therein a uniform resource locator (URL). With this, site information indicated by the set URL can be viewed and obtained as folder data or image data.

In the example shown in FIG. 4, a user identified as “user 001” can view and obtain (including print) a site “http://test.jp/”, and can also view and obtain image data held in a digital camera, a PC, and others.

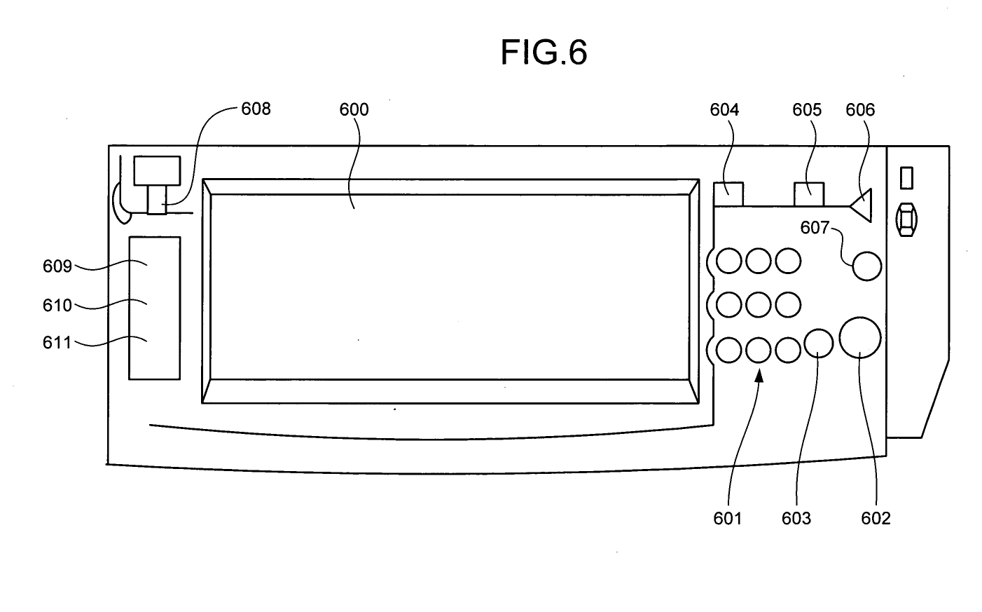

FIG. 6 is a plan view of a schematic configuration of the operating unit 320 according to the present embodiment. As shown in FIG. 6, the operating unit 320 is provided with the touch panel 600 as a main unit, and also numeric keys (enter keys) 601, a start key 602, a clear/stop key 603, a program key 604, a reset/preheat key 605, an interrupt key 606, a trial copy key 607, a setting key 608, and others.

The touch panel 600 is a liquid crystal display (LCD) unit as a part of an operation displaying unit capable of displaying icons and others indicative of operation conditions, such as output color and output paper size of the printing apparatus and capable of receiving settings of these operation conditions. A detection circuit and a coordinate detecting method for detecting that the touch panel 600 has been pressed are known, and will not be explained. The numeric keys (enter keys) 601 have both of a numeric-key function for entering a numerical value, such as the number of copies, and an enter-key function of confirming the input numerical value. The start key 602 is pressed for starting copying. The clear/stop key 603 is used for canceling an input numerical value, or suspending or terminating coping. The program key 604 is a key for registering or calling a frequently-used setting. The reset/preheat key 605 cancels the settings and then sets the machine in a preheat state when being pressed for an approximately one minutes or longer. The trial copy key 607 makes it possible to confirm the finish of a completed copy in order to prevent miscopy. The setting key 608 is a key for changing an initial setting value or operation condition according to use conditions.

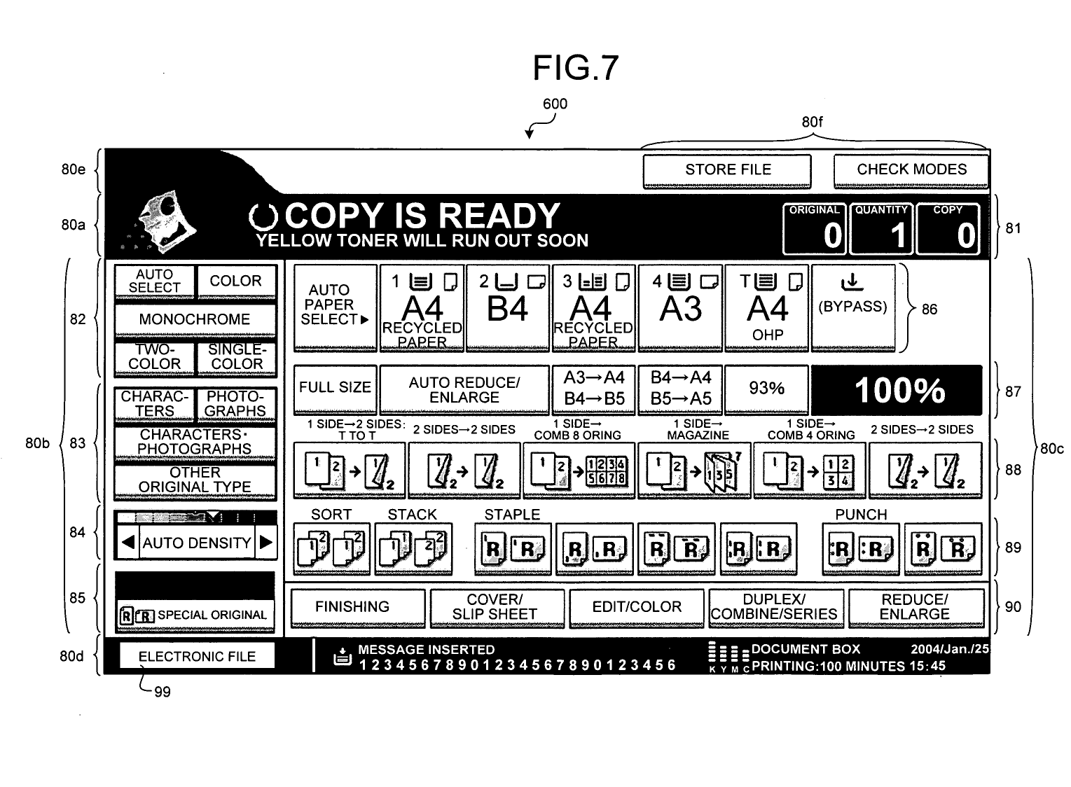

FIG. 7 is a drawing of an example of a basic screen displayed on the touch panel 600. On the basic screen, a display area 80a is displayed in which the number of document sheets read by the memory, the number of set sheets, the number of sheet copied are displayed, and also the state of operation, the operation procedure, a message, such as an error message, and others are displayed. Also, on a lower-left side of the display area 80a on the basic screen, a first touch panel area 80b (a display area 80b) regarding operations on the document is displayed. Furthermore, on a lower-right side of the display area 80a, a second touch panel area 80c (a display area 80c) regarding copy operations, such as paper size, scaling, and others, is displayed. Still further, on a lower side of the display areas 80b and 80c, a display area 80d is displayed, in which the name of a function during printing, finishing time, an error state in the entire printing apparatus, and others are displayed. On an upper side of the display area 80a, a third touch panel area 80f (a display area 80f) is displayed, in which a tab representing one job is displayed on a left side and a document storage key and setting check key, which are associated with the tab represented by the tab, are displayed on a right side. A classification as the touch panel areas 80b, 80c, and 80f is merely for convenience, and a display across the touch panel areas 80b, 80c, and 80f can be made on the touch panel 600.

In particular, the display area 80b is constructed of an output-color receiving area 82 for receiving selection of output color, a document-type receiving area 83 for receiving selection of whether the document image is a character, a photograph, a mixture thereof, or another document type (such as a copy document or a pale document), a density receiving area 84 for receiving a setting of density of a copy output, and a special-document receiving area 85 for receiving settings of a document size, an automatic document feeder (ADF), and a direction of setting a document to the printing apparatus.

On the other hand, the display area 80c is constructed of a paper-size receiving area 86 for receiving selection of an output paper size, a standard-scaling receiving area 87 for receiving scaling selection, such as same scaling or standard scaling from the size of the read document to a predetermined output paper size, a both-sides receiving area 88 for receiving selection of whether the read document and an output paper sheet is a one-side print or both-sides print, a post-process receiving area 89 for receiving selection of a post-process after copying, such as sorting, stacking, stapling, and punching, and a detailed-function receiving area 90 for receiving selection of a function item setting, such as scaling and edit copy. The second display item from the left in the paper-size receiving area 86 is explained as an example. A rectangle rendered with a black line represents a key, on which an icon representing the remaining amount of paper sheets, an icon representing an output orientation of the paper sheets, and a character “A4” are displayed. Also, the first display item from the left in the standard-scaling receiving area 87 is explained as an example. A rectangle also rendered with a black line represents a key, on which characters “same scaling” are displayed. Furthermore, as for the first display item from the left in the both-sides receiving area 88, a rectangle rendered with a black line represents a key, on which an icon representing a function of copying a one-side document to obtain a both-sides print is displayed.

Furthermore, in the display area 80d, an “electronic document” key 99 is displayed for the user to select when viewing folder data (including file data) stored in each external apparatus shown in FIG. 1 or obtaining file data from the external apparatuses.

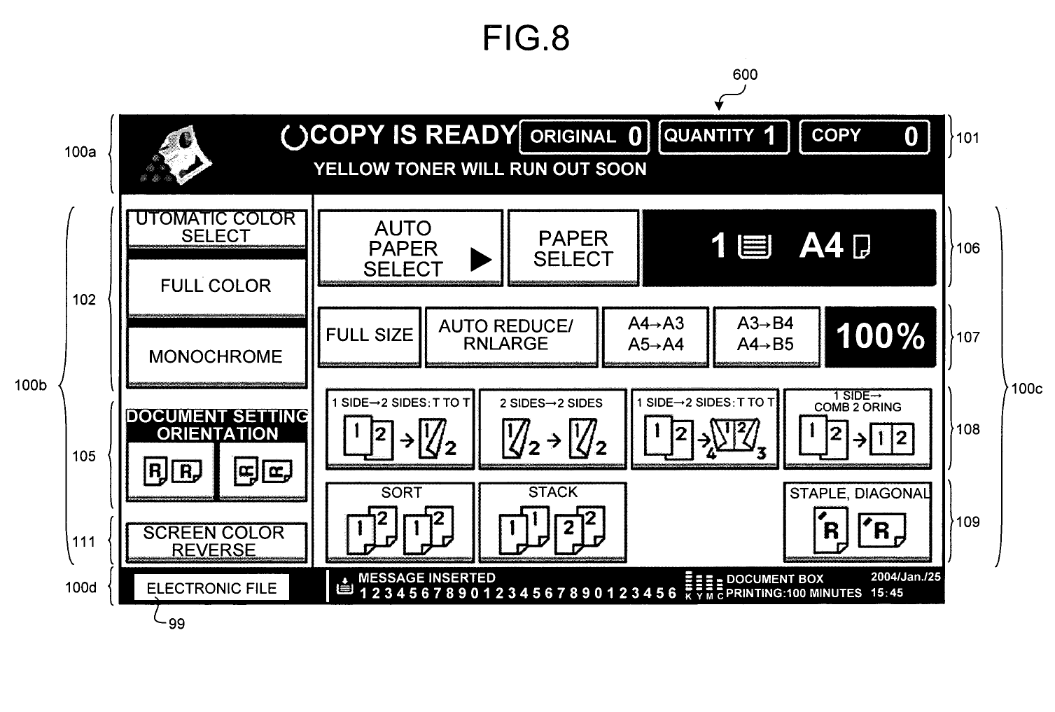

As explained above, rectangles each rendered with a black line and displayed on FIG. 7 and FIG. 8, which will be explained further below, represent keys. On each of these keys, an icon, a character(s), or both of an icon and a character(s) is displayed. Hereinafter, a portion represented as a key, a character(s), or an icon is assumed to represent an item explained above unless otherwise explained. Also, when a portion is represented simple by a “key”, it is assumed to include a character(s), an icon, or both of a key and a character(s) displayed on the key unless otherwise explained.

On the touch panel 600 according to the present embodiment, the display of the display screen can be changed according to user's preferences by switching an initial display (basic screen) to an abridged display (simple screen) as depicted from FIG. 8, in which only the keys for functions often used by the user, the operation procedure, descriptive text for an error display, and others are set in advance to be displayed.

On this simple screen, the basic screen is simplified as much as possible. By selecting (pressing) an input key displayed thereon, a pop-up screen is displayed or the screen display is changed, for example, thereby causing the next items related to the display items to be displayed. Then, by selecting from the next items an input key, an instruction input to the apparatus is provided. This simple screen is suitable for the user desiring simplicity of operation and understandability of display.

According to the present embodiment, switching can be made from the basic screen shown in FIG. 7 to the simple screen as shown in FIG. 8, or from the simple screen as shown in FIG. 8 to the basic screen shown in FIG. 7. On the simple screen shown in FIG. 8, the display area 80a, the display area 80b, the display area 80c, and the display area 80d of the basic screen shown in FIG. 7 correspond to a display area 100a, a display area 100b, a display area 100c, and a display area 100d, respectively in this order. Also, on the simple screen, display areas corresponding to the display area 80e and the display area 80f on the basic screen are omitted.

On the display area 100a, a display area 81 for the number of document sheets, the number of set sheets, and the number of sheet copied displayed in the display area 80a is disposed so as to be horizontally elongated on an upper portion of the display area 100a, and is displayed as a display area 101 with relatively large characters. Also, as shown in the display area 100a, the operation procedure and the message, such as an error message, are displayed with characters larger than those in the display area 80a. As such, the reason for the horizontally-elongated disposition on the upper portion of the display area 100a is that a display area is ensured even though the size of the characters of the message to be displayed in the display area 100a is increased.

Also, the display area 100b is constructed of an output-color receiving area 102 for receiving selection of output color, a document-setting-orientation receiving area 105 for receiving a setting of a setting orientation of a document to be set in an image forming apparatus, and a screen color reverse key 111 capable of reversing a screen color.

The output-color receiving area 102 has displayed therein three keys, whilst the output-color receiving area 82 corresponding to the output-color receiving area 102 has displayed therein five keys. Therefore, display of two keys (a bichrome key and a monochrome key) is deleted. Such a display is deleted on the simple screen because these two keys are hardly used by the user performing general operation. On the other hand, since the remaining three keys are used by any users with high frequency, these keys are displayed also on the simple screen. By using a portion of the display area from which two keys are deleted, the size of the remaining keys is increased compared with that on the basic screen, thereby achieving easy operation.

The function of the document-setting-orientation receiving area 105 is one of functions displayed when a special document setting key in the special-document receiving area 85 displayed in the display area 80b shown in FIG. 7 is pressed, and is composed of two keys, that is, a key for portrait document setting and a key for landscape document setting. Since these two keys are necessary functions even for users not requiring complex function settings (necessary functions for any operation), they are displayed independently on the simple screen as the document-setting-orientation receiving area 105. On the other hand, among the functions displayed when a special document setting key in the special-document receiving area 85 is pressed, functions not relevant to the document-setting-orientation receiving area 105 (items other than those for portrait document setting and landscape document setting) are not necessarily the function necessary for general operation. Therefore, these keys are not required for users desiring simplification and understandability of display and are thus not displayed. When the screen color reverse key 111 is selected, the display color on the screen is reversed. That is, the display is switched in a manner such that a black portion is changed to white, whilst a white portion is changed to black. With such a screen display, users who feel uncomfortable when viewing unreversed display can feel comfortable and can easily operate the screen display.

An abridged display of the display area 80c on the touch panel 600 is depicted as the display area 100c in FIG. 8. The display area 100c is constructed of a paper-size receiving area 106 for receiving selection of an output paper size, a standard-scaling receiving area 107 for receiving scaling selection, such as same scaling or standard scaling from the size of the read document to a predetermined output paper size, a both-sides receiving area 108 for receiving selection of whether the read document and an output paper sheet is a one-side print or both-sides print, and a post-process receiving area 109 for receiving selection of a post-process after copying, such as sorting, stacking, stapling, and punching.

The paper-size receiving area 106 is composed of three items: an automatic paper selection key for allowing automatic paper size selection, a paper selection key for developing a screen for arbitrary selection of a paper size, and an area on which the result of the paper size is displayed. For paper size selection, an operation setting is not necessarily required, but this function is relatively frequently used by any users. Therefore, first of all, on the simple screen in FIG. 8, in order to increase the size of keys and characters and also make paper size easy to select, only three items are displayed as mentioned above. When paper size selection is not used, only the automatic paper selection key is pressed. When paper size selection is desired to be used, the paper selection key is pressed, and the size selection result is displayed on the display area on the right side of the paper selection key.

Furthermore, the standard-scaling receiving area 107, the both-sides receiving area 108, and the post-process receiving area 109 on the simple screen in FIG. 8 correspond to the standard-scaling receiving area 87, the both-sides receiving area 88, and the post-process receiving area 89 on the basic screen in FIG. 7, respectively. However, the number of keys displayed in the standard-scaling receiving area 107 is less than that in the standard-scaling receiving area 87 by one. Also, the number of keys displayed in the both-sides receiving area 108 is less than that in the both-sides receiving area 88 by two. Furthermore, the number of keys displayed in the post-process receiving area 109 is less than that in the post-process receiving area 89 by five. In this manner, the configuration is such that the number of keys displayed in each display area is reduced. The standard-scaling receiving area 87, the both-sides receiving area 88, and the post-process receiving area 89 on the basic screen are display areas in which the user can assign in advance favorite functions to the respective keys. Also on the simple screen, the user can assign favorite functions. Although the number of keys assignable is small, the number of functions for use by the user using the simple screen is also small, and therefore a problem in operation with a shortage of keys does not occur. Thus, in the standard-scaling receiving area 107, the both-sides receiving area 108, and the post-process receiving area 109, only the keys of the functions required by the user can be displayed so as to be large and easy to use.

In the simple screen shown in FIG. 8 in contrast with the basic screen shown in FIG. 7, the display area 80e, the display area 80f, and the detailed-function receiving area 90 are not displayed. These areas are not displayed because the functions displayed in these areas are not necessarily functions required for basic function settings. By using the space for these functions, other display areas are ensured.

Furthermore, the display area 80d in FIG. 7 and the display area 100d in FIG. 8 are the same in the basic screen and the simple screen. These display portions are associated with the entire apparatus, and also are portions where an important error display and others are presented. However, in a normal state, these portions do not particularly require an operation, and therefore there is no change between the basic screen and the simple screen. Still further, as with the basic screen, the simple screen has displayed thereon the “electronic document” key 99 in the display area 100d, thereby allowing folder data to be viewed and obtained from not only the basic screen but also the simple screen.

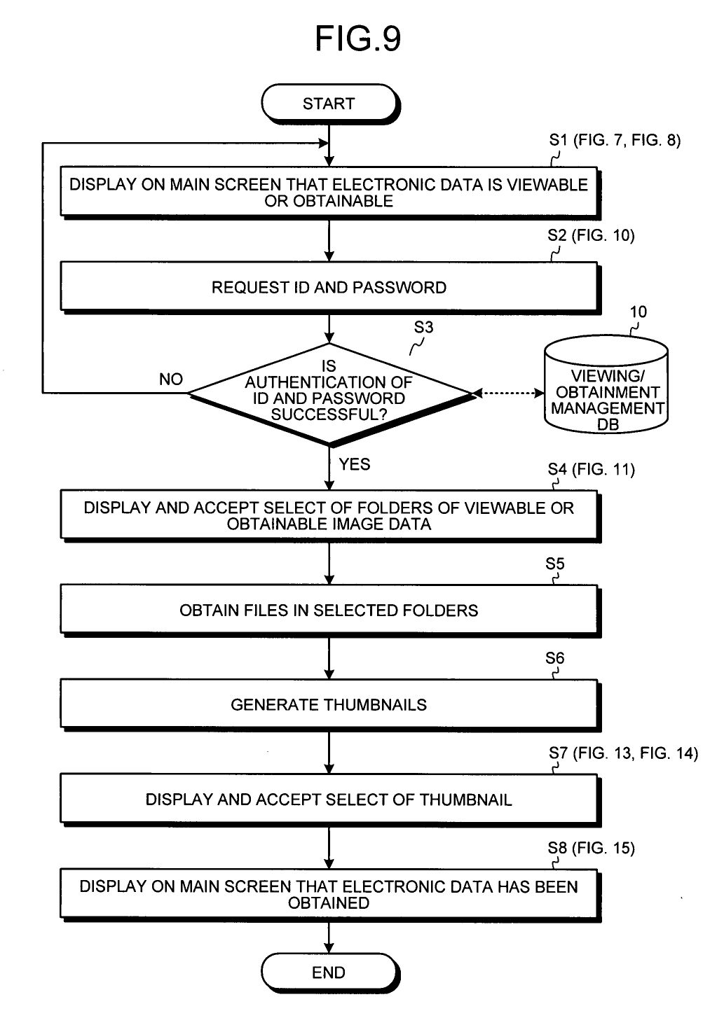

By referring to FIGS. 9 to 15, a method of obtaining folder data from each external apparatus by using the MFP 21 according to the present embodiment is explained (a folder data viewing method is omitted). FIG. 9 is a process flow of the procedure of the MFP 21 of obtaining image data and folder data from each external apparatus. In the following explanation, the screen in FIG. 7 or 8 is taken as a main screen.

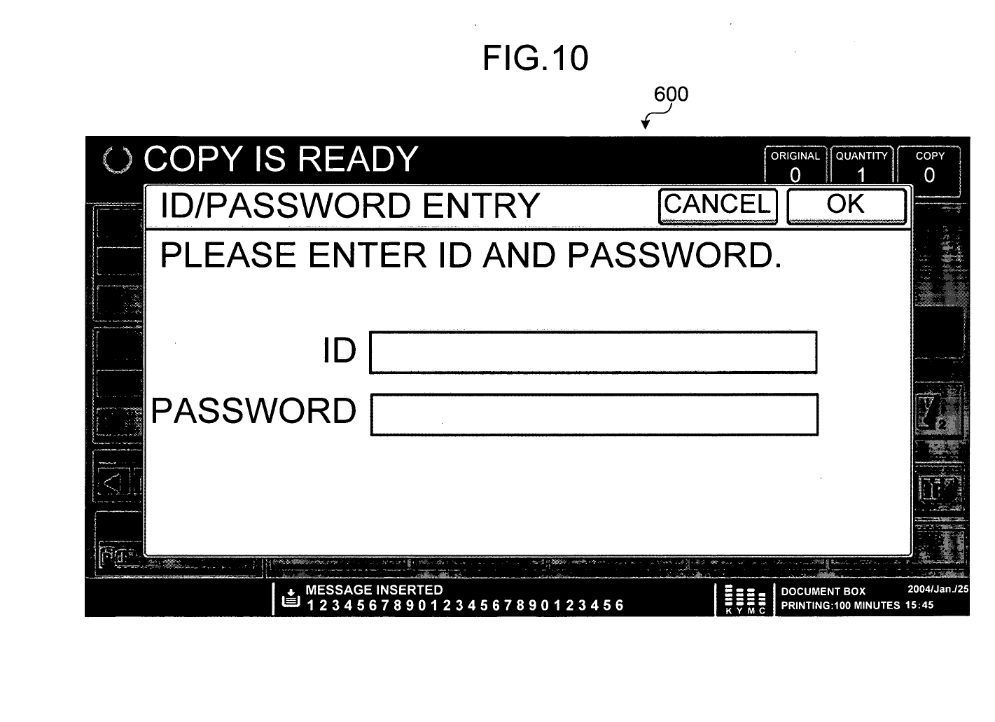

Normally, as shown in FIG. 7 or 8, the MFP 21 has the “electronic document” key 99 displayed on the main screen displayed on the touch panel 600, indicating that folder data can be viewed or obtained (step S1). In this state, when the user presses the “electronic document” key 99, the MFP 21 causes a screen for requesting an identification (ID) and a password as shown in FIG. 10 to be displayed on the touch panel 600 (step S2). With this, in each external apparatus, folder data viewable or obtainable by the user can be restricted. Also, among a plurality of pieces of folder data stored in the same external apparatus, folder data viewable or obtainable by the user can be restricted.

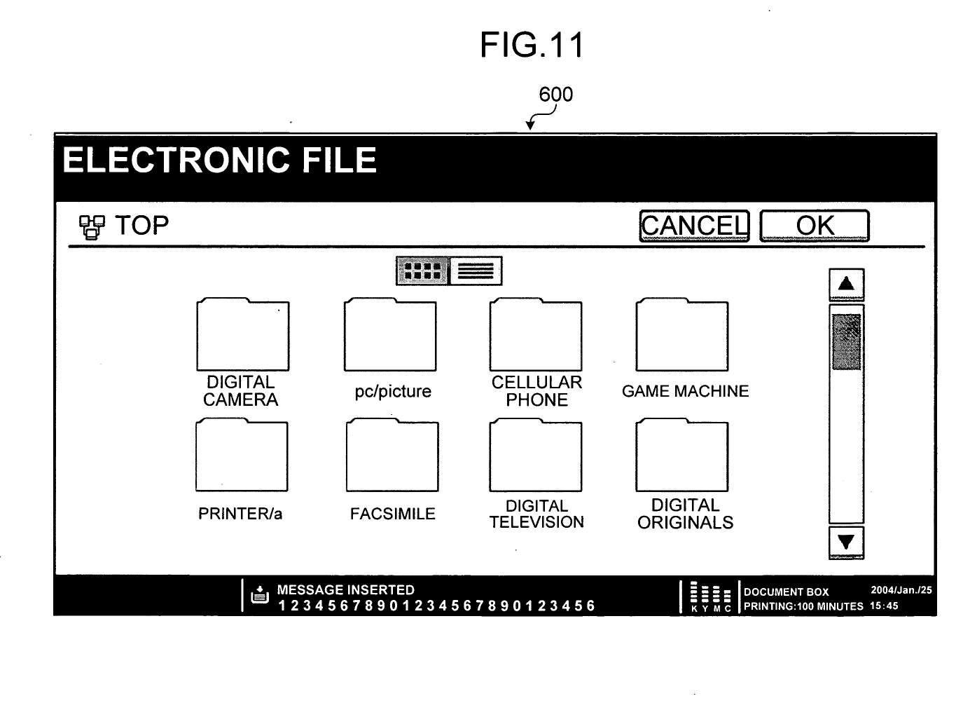

When the user enters his or her own ID and password with the numeric keys 601 or others, the MFP 21 searches the table shown in FIG. 4 based on the ID and the password for authentication for restricting viewing or obtainment by the user (step S3). When the MFP 21 determines that this authentication has failed (“No” at step S3), the procedure returns to step S1. When the MFP 21 determines that this authentication has been successful (“Yes” at step S3), a login process is performed, and then the display processing unit 504 causes a screen shown in FIG. 11 to be displayed on the touch panel 600.

The MFP 21 has displayed on the touch panel 600 folders of viewable or obtainable image data as shown in FIG. 11, and then receives selection of a folder from the user (step S4).

FIG. 11 is a drawing of an example of a folder-selection receiving screen caused by the display processing unit 504 to be displayed on the touch panel 600. As shown in FIG. 11, the display processing unit 504 causes folders of image data viewable or obtainable by the user (including external apparatuses connected to the network or folders in the external apparatus) to be displayed. Also, as shown in FIG. 11, the display processing unit 504 causes names of the external apparatuses, directory names of the external apparatuses, and others to be displayed as the folder names.

Furthermore, as shown in FIG. 11, the display processing unit 504 causes external apparatuses not continuously connected to the network, such as the digital camera 32, or folders of such external apparatuses to be displayed. This can be achieved because image data in these external apparatuses, such as the digital camera 32, is managed exemplarily by the management server 28a for each external apparatus. For display of the folder names, the display processing unit 504 causes not the folder names in the management server 28a but the names of the external apparatuses, which are targets for management by the management server 28a, to be displayed. With this, when viewing or obtaining image data, the user can easily determine which folder has the image data stored therein.

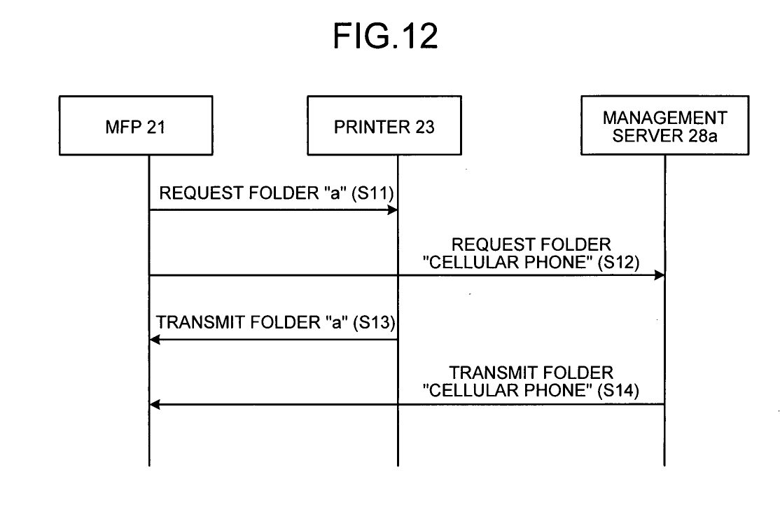

The case is explained in which a user A performs an obtaining process. FIG. 12 is a flowchart of the procedure of obtaining image data stored in a folder.

When the user A selects desired two items, that is, folder icons of “printer/a” and “mobile phone”, in FIG. 11, the folder-data requesting unit 512 of the MFP 21 requests the printer 23 having folder data “a” stored therein to transmit the folder data “a” (step S11). Together with the process at this step S11, the folder-data requesting unit 512 requests the management server 28a having folder data “mobile phone” stored therein to transmit the folder data “mobile phone” (step S12).

With this, the printer 23 transmits the folder data “a” to the MFP 21 (step S13). Then, the folder-data obtaining unit 513 obtains the transmitted folder data “a”.

The management server 28a transmits the folder data “mobile phone” to the MFP 21 (step S14). The folder-data obtaining unit 513 then obtains the transmitted folder data “mobile phone”. With this, the process of the MFP 21 and the external apparatus for obtaining folder data ends.

Referring back to FIG. 9, the folder-data obtaining unit 513 of the MFP 21 obtains the folder data “a” from the printer 23 and also obtains the folder data “mobile phone” from the management server 28a (step S5).

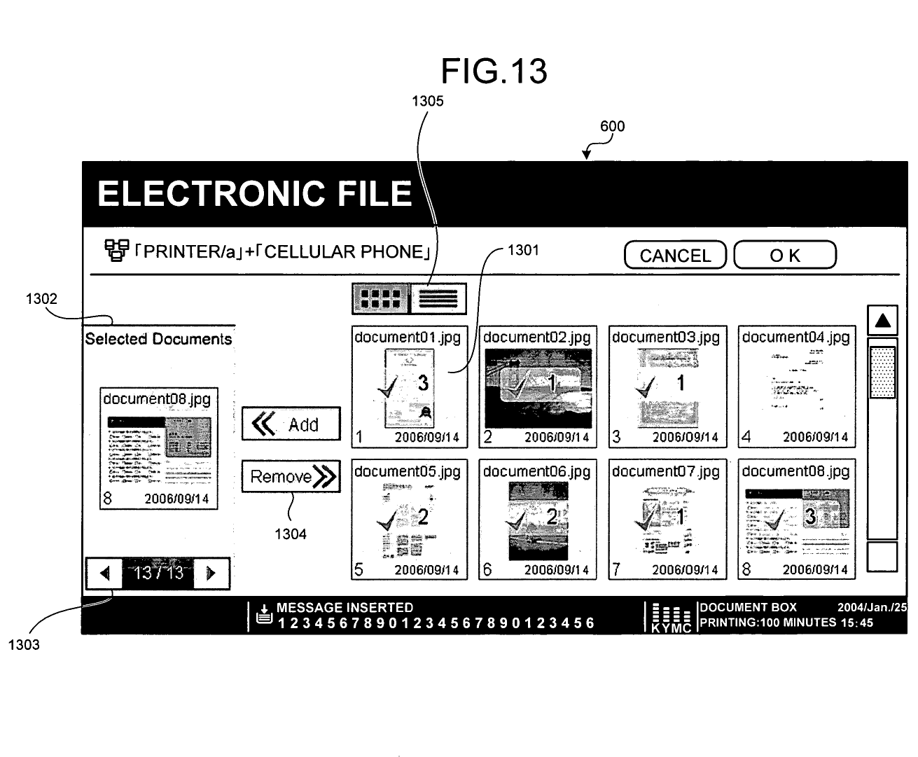

The thumbnail generating unit 503 generates thumbnail image data for all pieces of file data in the obtained folder data “a” and “mobile phone” (step S6). Then, with the display processing unit 504 causing thumbnail images as shown in FIG. 13 to be displayed on the touch panel 600, selection of a thumbnail image is received from the user (step S7).

FIG. 13 is a drawing of an example of a list of thumbnail images displayed on the touch panel 600. As shown in FIG. 13, the display processing unit 504 causes a file name and an image data creation date to be displayed for each piece of thumbnail image data. Such data is assumed to be obtained by the folder-data obtaining unit 513 from the external apparatuses. When the user selects a thumbnail image, the display processing unit 504 causes a check mark (for example, a check mark 1301) indicating that the thumbnail image has been checked to be displayed. The selecting unit 505 then selects, as a print target, image data from which the thumbnail image selected by the user is generated.

A number horizontally near the check mark of the thumbnail image represents the number of sets for printing the image data. In this manner, the user can arbitrarily change the number of prints. Also, the information displayed for each thumbnail image is not restricted to those explained above. For example, the number of pages at the time of printing may be displayed.

As shown in FIG. 13, the display processing unit 504 causes a list of the selected image data to be displayed in a “Selected Document” section 1302. The “Selected Document” section 1302 has displayed thereon thumbnails of the selected image data and a page information display section 1303. The page information display section 1303 has displayed thereon a page number of the displayed thumbnail, the total number of pages, and direction keys for changing a display page. When the user presses one of the direction keys, the display processing unit 504 causes a thumbnail image of the page of the movement destination to be displayed in the “Selected Document” section 1302, and also causes the page number in the page information display section 1303 to be changed. Also, while the display processing unit 504 is causing an arbitrary thumbnail image to be displayed, when the user presses a “Remove” button 1304, the selecting unit 505 selects the image data from which the thumbnail image is generated, and releases it from print targets. Furthermore, the display processing unit 504 causes a display form change button 1305 to be displayed. When the user presses the display form change button 1305, the display processing unit 504 switches the display between a display of thumbnails and a display of a file name list. In the screen example shown in FIG. 13, thumbnail images are displayed. An example in which the file name list is displayed is explained next.

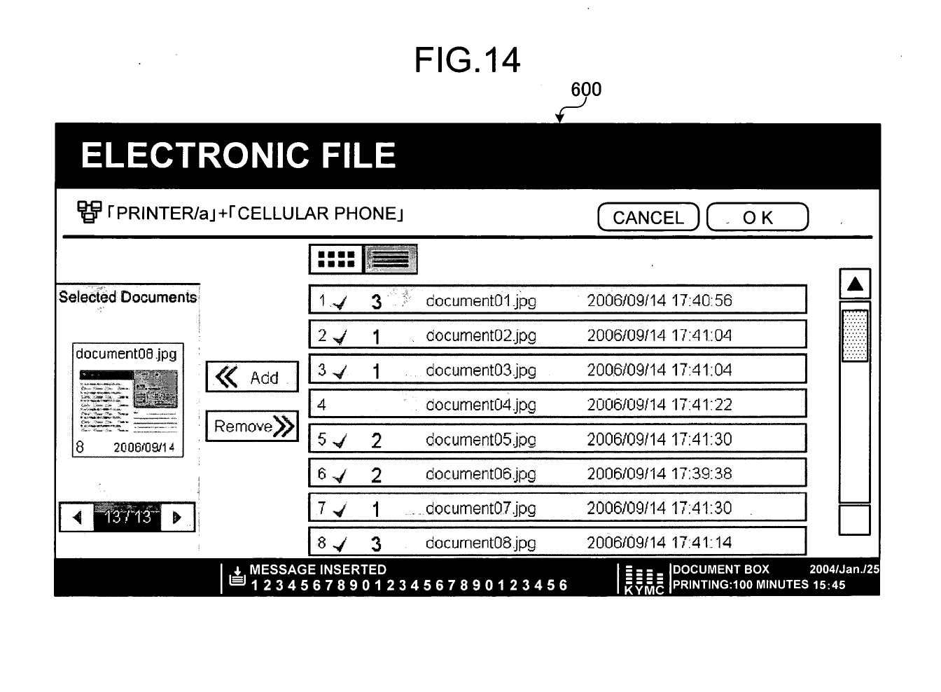

FIG. 14 is a drawing of an example of the file name list displayed on the touch panel 600. As shown in FIG. 14, the display processing unit 504 causes, for each piece of image data, a check mark indicating whether the image data has been checked, the number of prints, a file name, and a creation data to be displayed. Other information to be displayed is similar to that in the screen example shown in FIG. 13.

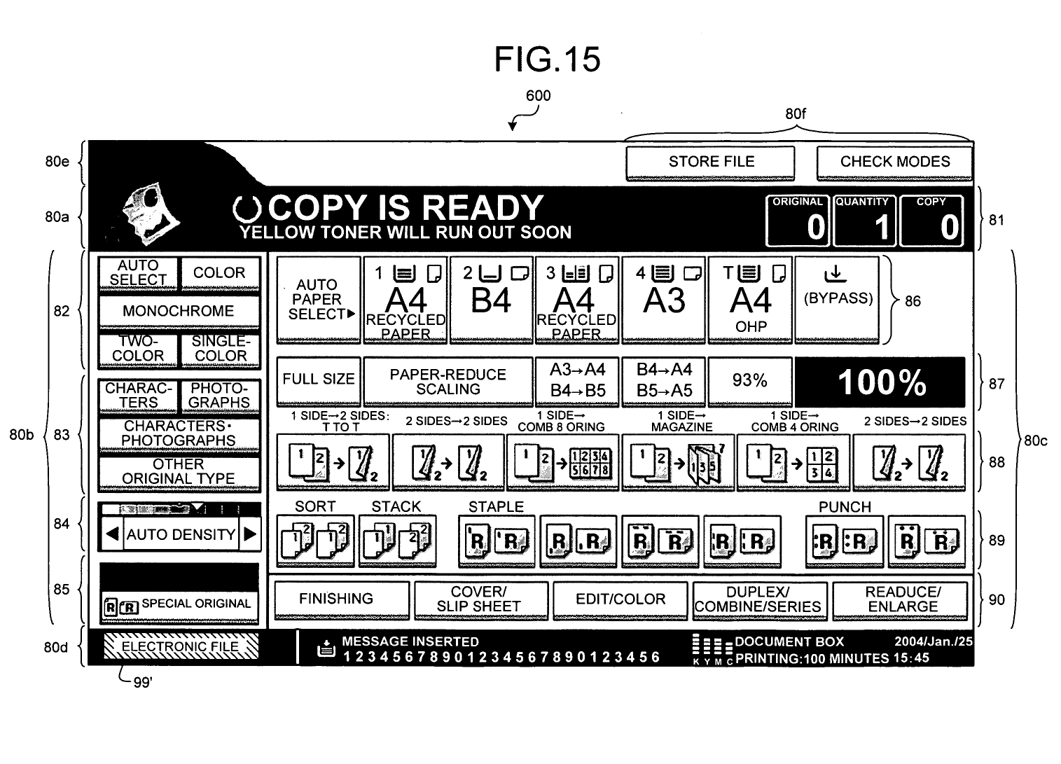

Referring back to FIG. 9, when the user selects a desired thumbnail and then selects an “OK” button through the screen shown in FIG. 13 or 14, the display processing unit 504 causes a main screen as shown in FIG. 15 to be displayed on the touch panel 600 (step S8). On this main screen, the “electronic document” key 99′ changed in display form (for example, key color) is displayed, thereby making the user notice that the electronic data has been obtained. Then, when printing the obtained electronic data, the user selects an output paper sheet, print color, and others, as with the main screen shown in FIG. 7 or 8, for settings as normal print settings. This allows the printing unit 506 to output image data, which is image data associated with the thumbnail image selected by the user, for printing.

As describe above, according to the present embodiment, PULL-type printing is performed, in which image data is obtained for printing from outside of the MFP 21, thereby increasing the number of pieces of print target data.

The thumbnail image data of the externally-obtained image data is generated for the user to select a print target therefrom. With this, even when many pieces of externally-obtainable image data (image data according to the present embodiment) are present, they can be output for printing in an organized manner.

Furthermore, as shown in FIGS. 7 and 8, even when different screens are displayed on the touch panel 600, the “electronic document” key 99 is always displayed. With this, a transition can be made from various screens (FIGS. 7 and 8) to the screen for obtaining images shown in FIG. 10. Therefore, user operability can be increased.

The image data according to the present embodiment is assumed to include not only general image data, such as drawing, graph, and photographic data, but also document files. Still further, the image data may include presentation files, for example. Still further, the image data may be a combination of a drawing, a graph, a photograph, a document, and others. Still further, the image data can take any format as long as it is a file format taken as a print target at the printing apparatus. For example, examples of the image data format may include, in addition to an image data format, such as “JPEG”, but also a document data format, such as “DOC”, a presentation file format, such as “PPT”, and a spreadsheet software format.

When the image data file format is either of a document file format and a presentation file format, irrespectively of whether the image data is held in an external apparatus, the MFP 21 causes thumbnail image data indicating the first page of the image data to be displayed on the touch panel 600. Then, as with the process explained above, when receiving selection of thumbnail image data from the user, the MFP 21 prints the image data in either of the document file format and the presentation file format represented by the thumbnail image data.

The embodiment explained above is not meant to be restrictive, and various modifications can be made as exemplified below.

According to the first embodiment, when the folder-data requesting unit 512 requests transmission of a plurality of pieces of folder data, the folder-data obtaining unit 513 obtains the folder data and causes a list of thumbnail images generated from image data stored in these pieces of folder data to be displayed. In the first embodiment, however, the display scheme explained above is not meant to be restrictive. In a modification example of the first embodiment, an example of a different display of folders is explained. The configuration of the MFP 21 is similar to that according to the first embodiment.

In the modification example, the display processing unit 504 causes a display screen shown in FIG. 11 to be displayed. The touch panel 600 then receives only a selection of one folder. When the user selects one folder from the folders, through the processes explained above by the folder-data requesting unit 512 and the folder-data obtaining unit 513, the selected one piece of folder data is obtained. Then, after the thumbnail generating unit 503 generates thumbnail image data from image data in the folder, the display processing unit 504 causes a list of thumbnail images in the folder to be displayed.

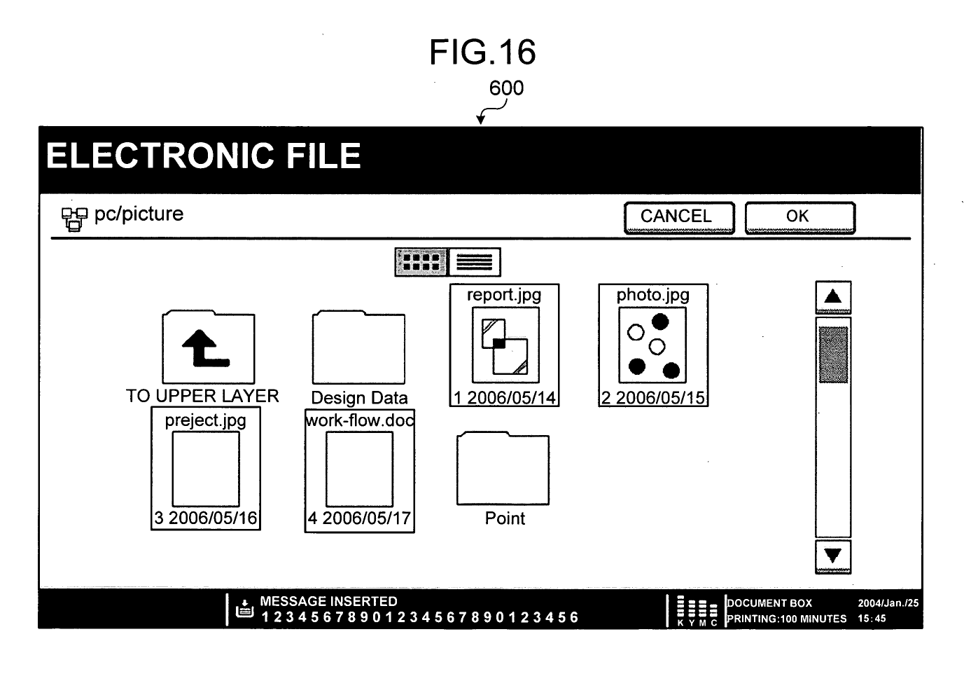

FIG. 16 is a drawing of an example of the thumbnail image list displayed on the touch panel 600 by the display processing unit 504. As shown in FIG. 16, the display processing unit 504 causes image data stored in the folder selected by the user and a list of folders that are present in that folder to be displayed. When the user selects one of the displayed folders, the display processing unit 504 performs the process explained above, thereby performing a display process on the folders and image data in the selected folder. That is, in the modification example, the display processing unit 504 changes the folder to be displayed so as to move in a folder-group tree structure including a plurality of external apparatuses.

When the user selects image data from the screen shown in FIG. 16, the display processing unit 504 causes the “Selected Document” section shown in FIG. 13 or 14 according to the first embodiment to be displayed, thereby causing a thumbnail image of the selected image data to be displayed. The selected image data is also held when a folder changing process is performed. With this, the user can select image data to be printed from the external apparatuses.

According to the first embodiment, thumbnail image data is generated in the MFP 21. However, this is not meant to be restrictive. In a second embodiment of the present invention, an example is explained in which thumbnails are generated in an external apparatus.

According to the present embodiment, an external apparatus capable of generating thumbnail image data, such as the digital camera 32, generates thumbnail image data from image data stored in the external apparatus. For an external apparatus not continuously connected to the network, upon connection to the network, the external apparatus transmits the generated thumbnail image data together with the original image data to the management server 28a.

Furthermore, according to the present embodiment, it is assumed that an apparatus capable of generating thumbnail image data is present also in an external apparatus continuously connected to the network, such as the printer 23 and the FAX 24.

For an external apparatus not generating thumbnail image data, such as the car navigation system 29 and the notebook PC 33, such an external apparatus transmits image data to the management server 28a. The management server 28a then generates thumbnail image data from the received image data, and manages the thumbnail image data together with the image data. For such an external apparatus not capable of generating thumbnail image data, a procedure similar to the procedure explained in the first embodiment is assumed to be performed, and is therefore not explained herein.

In the ROM 212a of the management servers 28a and 28b, for managing also the thumbnail image data, a viewing/obtainment management DB 1700 that is different from that in the first embodiment is constructed.

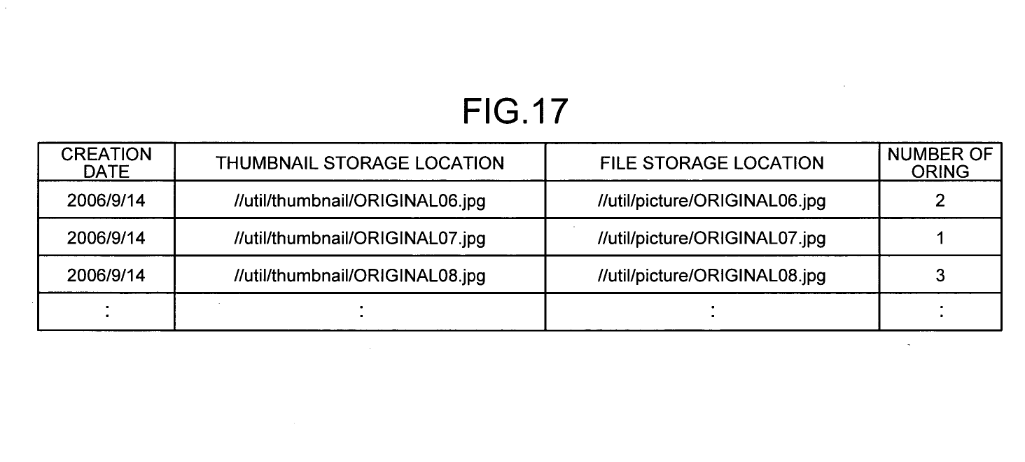

FIG. 17 is a drawing of an example of a viewing/obtainment management table stored in the viewing/obtainment management DB 1700. As shown in FIG. 17, the viewing/obtainment management table has a creation date, a thumbnail storage location, a file storage location, and the number of pages of the file managed in association with each other. With the management server 28a holding such a table, the thumbnail image data and the image data from which the thumbnail image data is generated can be transmitted in response to a request from the MFP or the like.

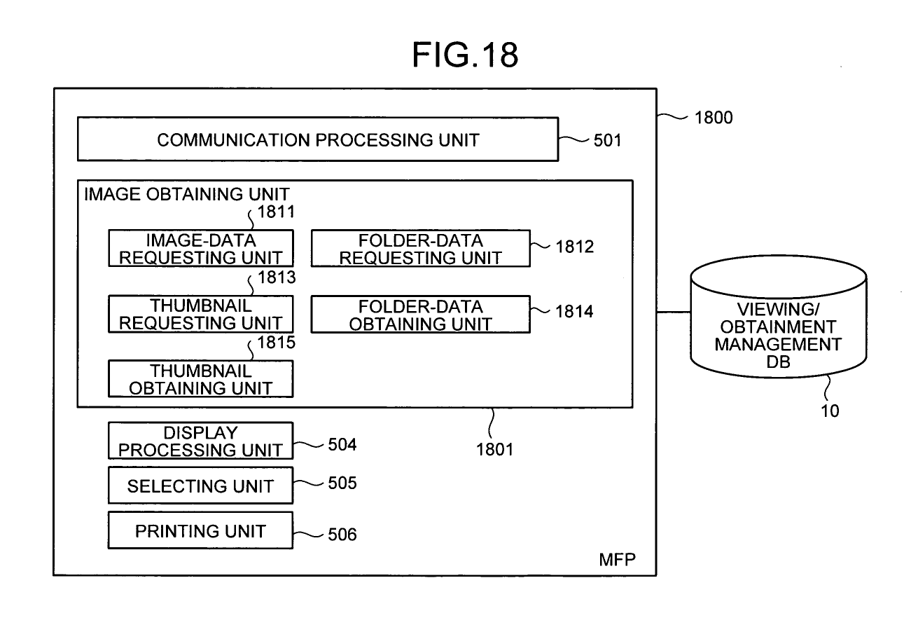

FIG. 18 is a block diagram of the configuration of an MFP 1800 according to the second embodiment. The MFP 1800 is different from the MFP 21 according to the first embodiment mentioned above in that the image obtaining unit 502 is changed to an image obtaining unit 1801, which performs processing different from that of the image obtaining unit 502. In the following explanation, components identical to those in the first embodiment are provided with the same reference numerals, and are not explained herein.

The image obtaining unit 1801 includes an image-data requesting unit 1811, a folder-data requesting unit 1812, a folder-data obtaining unit 1814, a thumbnail requesting unit 1813, and a thumbnail obtaining unit 1815, and obtains, from an external apparatus, thumbnail image data and image data from which the thumbnail image data is generated.

The thumbnail requesting unit 1813 requests the external apparatus to transmit the thumbnail image data. When image data is managed for each folder at the storage unit of the external apparatus, if a request for transmitting thumbnail images for each folder is issued to the external apparatus, such a transmission request is issued from the folder-data requesting unit 512 as explained further below.

The thumbnail obtaining unit 1815 obtains the thumbnail image data contained in the folder from the external apparatus responding to the transmission request from the thumbnail requesting unit 1813.

The folder-data requesting unit 1812 issues a request for transmitting the thumbnail image data contained in each folder to the external apparatus.

The folder-data obtaining unit 1814 obtains the image data and folder data contained in the folder from the external apparatus responding to the transmission request from the folder-data requesting unit 1812.

The image-data requesting unit 1811 requests the external apparatus to transmit the image data from which the thumbnail image data selected by the user is generated. With this, the image obtaining unit 1801 can obtain the image data from which the thumbnail image data is generated.

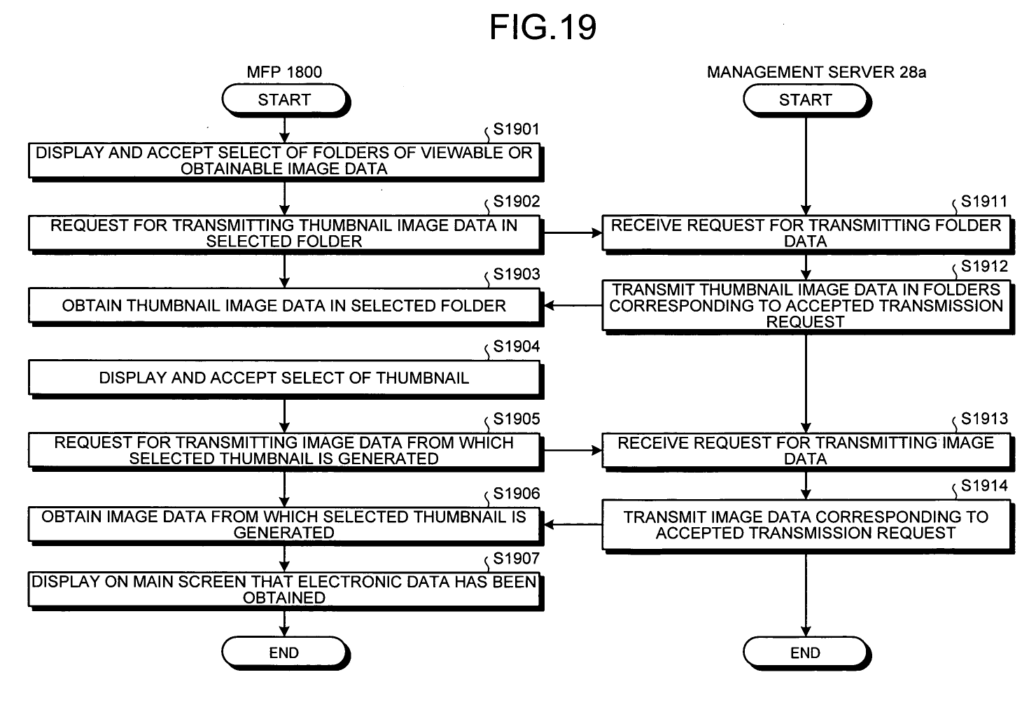

The procedure until the MFP 1800 according to the present embodiment obtains image data from each external apparatus is explained. FIG. 19 is a process flow of the procedure until the MFP 1800 obtains image data. In the procedure, the case is explained in which the apparatus transmitting and receiving data to and from the MFP 1800 is the management server 28a. A login process is similar to that in the first embodiment.

First, the display processing unit 504 causes folders of viewable or obtainable image data as shown in FIG. 11 to be displayed on the touch panel 600, and then receives selection of a folder from the user (step S1901).

When selection of a folder is received from the user, the folder-data requesting unit 512 outputs a request for transmitting the selected folder data to the management server 28a having that folder (step S1902).

The management server 28a then receives the request for transmitting the folder data from the MFP 1800 (step S1911). At the management server 28a, thumbnail images of the image data in the folder have been generated, as explained above.

Then, the management server 28a transmits the folder data corresponding to the received transmission request (the thumbnail image data in the folder and information about folders contained in that folder) to the MFP 1800 (step S1912).

The folder-data obtaining unit 1814 of the MFP 1800 then obtains the folder data transmitted from the management server 28a (step S1903). The folder data includes the information about the folders contained in the folder and the thumbnail image data generated from the image data stored in the folder.

The display processing unit 504 causes the thumbnail images as shown in FIG. 13 to be displayed on the touch panel 600, thereby receiving selection of a thumbnail image from the user (step S1904).

When the user selects a desired thumbnail from the screen shown in FIG. 13 or 14 and then selects the “OK” button, the image-data requesting unit 1811 requests the management server 28a to transmit image data from which the selected thumbnail image data is generated (step S1905).

The management server 28a receives the image data transmission request from the MFP 1800 (step S1913).

The management server 28a then transmits the image data corresponding to the received transmission request to the MFP 1800 (step S1914).

The image obtaining unit 1801 of the MFP 1800 obtains from the management server 28a the image data from which the selected thumbnail image is generated (step S1906).

The display processing unit 504 then causes the main screen as shown in FIG. 15 to be displayed on the touch panel 600 (step S1907). With this, the image data can be printed.

Through the procedure explained above, the image data stored in the storage unit of the external apparatus can be accessed for printing. According to the present embodiment, also for the external apparatus continuously connected to the network, such as the printer 23 or the FAX 24, processing similar to that in the management server 28a shown in FIG. 19 is assumed to be performed, and is therefore not explained herein.

According to the present embodiment, it is assumed that, after the thumbnail image data is transmitted and received between the MFP 1800 and the external apparatus, the image data from which the thumbnail image data selected by the user is generated is transmitted and received. With such a process, the amount of data to be transmitted and received can be reduced. Therefore, the load on the network can be reduced, and also the list of thumbnail images can be quickly displayed at the MFP 1800 upon request from the user.

According to the second embodiment, after the external apparatus transmits the thumbnail image data, when the user selects a thumbnail image at the MFP 1800, the MFP 1800 obtains from the external apparatus the image data from which the thumbnail image is generated. However, such an image data obtaining process is not meant to be restrictive. For example, before the thumbnail image data is displayed, the thumbnail image data and the image data from which the thumbnail image data is generated may be simultaneously obtained from the external apparatus.

A printing process program to be executed on the MFP according to any embodiment explained above may be configured to be stored in a computer connected to a network, such as the Internet, and be provided by being downloaded via the network. Also, the printing process program to be executed on the MFP according to the embodiment may be configured to be provided or distributed via a network, such as the Internet.

Furthermore, the printing process program according to the embodiment may be configured to be provided as being incorporated in advance in a ROM or the like.

The printing program to be executed on the MFP according to the embodiment has a module configuration including the components explained above. As actual hardware, the CPU reads the printing process program from the recording medium for execution, thereby causing each component to be loaded and generated onto a main storage unit.

The program can be distributed as being recorded on a recoding medium, such as a CD-ROM.

As described above, according to an aspect of the present invention, an effect can be achieved such that, with an operation of actively obtaining image data from the printing apparatus side, print targets can be actively expanded on the printing apparatus side.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for printing input image data, the apparatus comprising:
an image obtaining unit that obtains image data stored in a storage unit of an external apparatus; and
a printing unit that prints obtained image data.

2. The apparatus according to claim 1, wherein
the image obtaining unit includes an image-data requesting unit that requests the image data to the external apparatus, and
the image obtaining unit obtains the image data from the external apparatus that responded a request from the image-data requesting unit.

3. The apparatus according to claim 1, further comprising:
a thumbnail generating unit that generates thumbnail image data of the obtained image data;
a display processing unit that displays a thumbnail image of generated thumbnail image data; and
a selecting unit that receives a selection of a thumbnail image by a user from among thumbnail images displayed by the display processing unit, and selects image data that is a source of the thumbnail image data for which the selection is received as a print target, wherein
the printing unit prints the image data selected as the print target.

4. The apparatus according to claim 3, wherein
the image obtaining unit obtains image data from each of a plurality of external apparatuses,
the selecting unit selects a plurality of image data obtained from each of the external apparatuses as the print target, and
the printing unit collectively prints selected image data.

5. The apparatus according to claim 3, wherein
the image obtaining unit includes
a folder-data requesting unit that requests data on a folder that stores the image data to be obtained to the external apparatus, and
a folder-data obtaining unit that obtains the data on the folder from the external apparatus that responded a request from the folder-data requesting unit, and
the thumbnail generating unit generates thumbnail image data of image data stored in the folder for which the data on the folder is obtained.

6. The apparatus according to claim 3, wherein
the image obtaining unit obtains image data from a plurality of external apparatuses, and
the display processing unit displays a folder indicating the external apparatus for each of the external apparatuses, and when a selection of a folder is received from among displayed folders, displays a thumbnail image generated from image data obtained from the external apparatus corresponding to the folder for which the selection is received.

7. The apparatus according to claim 1, wherein
the image obtaining unit includes a thumbnail obtaining unit that obtains thumbnail image data from the external apparatus,
the apparatus further comprises
a display processing unit that displays a thumbnail image of obtained thumbnail image data; and
a selecting unit that receives a selection of a thumbnail image by a user from among thumbnail images displayed by the display processing unit, and selects image data that is a source of the thumbnail image data for which the selection is received as a print target, and
the image obtaining unit obtains the image data selected as the print target from the external apparatus.

8. The apparatus according to claim 7, wherein
the thumbnail obtaining unit obtains the thumbnail image data from each of a plurality of external apparatuses,
the selecting unit selects the image data selected as the print target for each of the external apparatuses, and
the image obtaining unit obtain the image data selected as the print target from each of the external apparatuses.

9. A method of printing input image data, the method comprising:
obtaining image data stored in a storage unit of an external apparatus; and
printing obtained image data.

10. The method according to claim 9, wherein the obtaining includes
requesting the image data to the external apparatus, and
obtaining the image data from the external apparatus that responded a request made at the requesting.

11. The method according to claim 9, further comprising:
generating thumbnail image data of the obtained image data;
displaying a thumbnail image of generated thumbnail image data; and
selecting includes
receiving a selection of a thumbnail image by a user from among thumbnail images displayed at the displaying, and
selecting image data that is a source of the thumbnail image data for which the selection is received as a print target, wherein
the printing includes printing the image data selected as the print target.

12. The method according to claim 11, wherein
the obtaining includes obtaining image data from each of a plurality of external apparatuses,
the selecting includes selecting a plurality of image data obtained from each of the external apparatuses as the print target, and
the printing includes printing collectively selected image data.

13. The method according to claim 11, wherein
the obtaining includes
requesting data on a folder that stores the image data to be obtained to the external apparatus, and
obtaining the data on the folder from the external apparatus that responded a request made at the requesting, and
the generating includes generating thumbnail image data of image data stored in the folder for which the data on the folder is obtained.

14. The method according to claim 11, wherein
the obtaining includes obtaining image data from a plurality of external apparatuses, and
the displaying includes
displaying a folder indicating the external apparatus for each of the external apparatuses, and
displaying, when a selection of a folder is received from among displayed folders, a thumbnail image generated from image data obtained from the external apparatus corresponding to the folder for which the selection is received.

15. The method according to claim 9, wherein
the obtaining includes obtaining thumbnail image data from the external apparatus,
the method further comprises
displaying a thumbnail image of obtained thumbnail image data; and
selecting including
receiving a selection of a thumbnail image by a user from among thumbnail images displayed at the displaying, and
selecting image data that is a source of the thumbnail image data for which the selection is received as a print target, and
the obtaining image data includes obtaining the image data selected as the print target from the external apparatus.

16. The method according to claim 15, wherein
the obtaining thumbnail image data includes obtaining the thumbnail image data from each of a plurality of external apparatuses,
the selecting includes selecting the image data selected as the print target for each of the external apparatuses, and
the obtaining image data includes obtaining the image data selected as the print target from each of the external apparatuses.

17. A computer program product comprising a computer-usable medium having computer-readable program codes embodied in the medium that when executed cause a computer to execute:
obtaining image data stored in a storage unit of an external apparatus; and
printing obtained image data.
